(19) United States
(12) Patent Application Publication
(10) Pub. No.: US 2026/0142714 A1
(43) Pub. Date: May 21, 2026

(54) RADIO COMMUNICATION RELAY MODULE AND SYSTEM

(71) Applicant: Government of the United States, as represented by the Secretary of the Air Force, Wright-Patterson AFB, OH (US)

(72) Inventors: Michael Sedillo, Dayton, OH (US); Nathan Stover, Xenia, OH (US); Matthew Stechschulte, Waynesville, OH (US); Matthew Scharf, Fairborn, OH (US); Matthew Seymour, Springboro, OH (US)

(73) Assignee: Government of the United States, as represented by the Secretary of the Air Force, Wright-Patterson AFB, OH (US)

(21) Appl. No.: 18/954,740

(22) Filed: Nov. 21, 2024

(51) Int. Cl. H04B 7/15

(52) U.S. Cl. CPC H04B 7/15

(57) ABSTRACT

A radio communication relay module and system for radio communication systems that allow radio operators to transition from operation outside a structure such as a vehicle or building to operation inside such a structure are provided. The module has a radio interface for connecting to a radio, and a first interface cable for connecting the module to a second interface cable. The second interface cable connects to a power supply and antenna of the vehicle or other structure. When the first and second interface cables are connected, the radio uses the structure's antenna and power system.

### RIGHTS OF THE GOVERNMENT

The invention described herein may be manufactured and used by or for the Government of the United States for all governmental purposes without the payment of any royalty.

### FIELD OF THE INVENTION

The present invention relates generally to radio communication systems and, more particularly, to interfaces for radio communication systems that allow radio operators to transition between operation outside a structure, such as a vehicle or building, and operation inside such a structure.

### BACKGROUND OF THE INVENTION

Man-pack radios are communications systems that are compact and lightweight enough to be carried by a single operator, typically in a backpack. Military man-pack radios are used by a wide range of forces and operators including infantry, special forces, and naval and air force personnel. Man-pack radios are designed for use by dismounted troops, and to be mounted in vehicles or operations centers.

While inside a vehicle, the radio operator's man-pack radio will not transmit through the vehicle's body, so a radio-operator must use a different vehicle-integrated-radio to communicate through the vehicle's antenna-amplifiers and power system. The radio operator's personal communications equipment does not easily interface to the vehicle, so they often need to remove their helmet/headset to use the handset that is attached to the vehicle-mounted radio. When the operator needs to exit the vehicle, they must don all the communications equipment previously removed to convert back to dismounted operations.

Currently, two radios are required to allow a radio operator to communicate both inside and outside of a vehicle. The personal radio they wear on their body or carry in a backpack is used when walking outside of a vehicle. When they climb into the vehicle, their personal radio becomes useless since it cannot broadcast or receive communication signals inside the shielded vehicle. The radio operator must convert to using an identical radio that is installed in the vehicle and integrated into the vehicle's antenna amplifiers and power. Their personal radio sits on the floor of the vehicle serving no purpose and is usually left powered-ON to allow quick transit to ground operations should the need arise for a rapid egress. This usually results in the battery being depleted when they need it most. To enable these operations, organizations purchase and maintain twice as many radios as is necessary to accomplish their missions.

Requiring additional radios for vehicle operations is costly in having to purchase and maintain the radios, and time consuming to load cryptography-codes and set frequencies on both radios. To communicate on the radio in a non-radio equipped vehicle, personnel must exit the vehicle with their personal man-pack radios to allow the radio to receive and transmit information. These actions potentially expose them to enemy fire by not being able to communicate within the vehicle.

A need, therefore, exists for an interface for radio communication systems that allows radio operators to quickly transition between operation outside a structure, such as a vehicle or building, and operation inside such a structure.

### SUMMARY OF THE INVENTION

The present invention relates generally to radio communication systems and, more particularly, to interfaces for radio communication systems that allow radio operators to transition between operation outside a structure, such as a vehicle or building, and operation inside such a structure.

While the invention will be described in connection with certain embodiments, it will be understood that the invention is not limited to these embodiments. To the contrary, this invention includes all alternatives, modifications, and equivalents as may be included within the spirit and scope of the present invention.

According to one embodiment of the present invention, a radio communication relay module is provided. The radio communication relay module is configured for interfacing with a portable radio having a battery, and interfacing with the antenna and power supply within a structure. The radio communication relay module comprises:
a housing comprising a radio interface configured to connect to a portable radio and a battery interface configured to connect to the battery of the portable radio, wherein the battery interface comprises a mechanism to detect whether the battery of the radio is non-rechargeable or rechargeable; and
a first interface device cable having a proximal end joined to the housing and a distal end spaced away from the housing, wherein the distal end of the first interface device cable is configured to at least indirectly connect the module to a structure's external antenna and power supply.

In another embodiment, a system is provided. The system comprises the radio communication relay module and a second interface device cable that is configured to be joined to a structure's antenna and power supply. The second interface device cable has a proximal end configured to be joined to a structure's antenna and power supply and a distal end spaced away from the proximal end. The distal end of the second interface device cable is configured to connect to the distal end of the first interface device cable.

The system may further comprise a radio (e.g., a two-way radio) having a battery. The radio may have antenna ports, such as for a UHF antenna and a VHF antenna.

The radio may be provided with antenna switches that are located between the radio and the respective antenna. The antenna switches may be configured to automatically switch from the radio's antennas to the structure's (e.g., vehicle's) antenna when power is provided to the radio communication relay module by the structure's power supply. In an alternative embodiment, only the antenna switches may be provided as part of the system, and the radio may comprise a separate component onto which the antenna switches are installed.

In another embodiment, a method of interfacing a portable radio having a battery with a structure's antenna and power supply is provided. The method comprises:
a) providing a radio communication relay module that is joined to a portable radio having a battery, the module being configured to interface with the radio and with a structure's antenna and power supply, the module comprising:
   a housing comprising a radio interface connected to a portable radio and a battery interface connected to the battery of the portable radio;
   a first interface device cable having a proximal end joined to the housing and a distal end spaced away from the housing, wherein the distal end of the first interface device cable is configured to connect the module at least indirectly to a structure's antenna and power supply; and
b) providing a second interface device cable that is operatively connected to a structure's antenna and power supply; and
c) bringing the radio with the radio communication relay module joined thereto into the structure; and
d) connecting the first interface device cable and the second interface device cable, wherein the radio communication relay module is configured so that when the first and second interface device cables are connected, the radio uses the structure's antenna and power system.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 is a perspective view of a radio communication relay module (installed on a tactical radio).

FIG. 2A is perspective view of the top of one embodiment of a radio communication relay module.

FIG. 2B is a perspective view of a system comprising the radio communication relay module in FIG. 2A and the first and second interface device cables.

FIG. 2C is a perspective view of the radio communication relay module shown together with a radio and a battery pack for the radio.

FIG. 3A is a perspective view of the first and second interface device cable connectors in an unconnected configuration.

FIG. 3B is a perspective view of the first and second interface device cable connectors in a connected configuration.

FIG. 3C is a perspective view of an antenna switch.

FIG. 4 is a perspective view of a radio next to the radio communication relay module that is joined to the battery pack of the radio.

FIG. 5 is a block diagram that shows the relationship of the main components of the interface module, the radio, and the vehicle amplifiers and power.

FIG. 6 is a diagram of the overview of the system.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity of illustration.

### DETAILED DESCRIPTION OF THE INVENTION

The present invention relates generally to radio communication systems and, more particularly, to interfaces for radio communication systems that allow radio operators to transition between operation outside a structure (or enclosed space), such as a vehicle, building, or ship, and operation inside such a structure. Such structures may be referred to herein as “shielded structures” in that the radio signal would otherwise be attenuated by the structure, if not for the radio communication relay system described herein.

Although some of the embodiments are described herein in terms of use of the radio communication system within a vehicle, it is understood that the radio communication system can be used within any suitable structure(s). Therefore, the term “vehicle” may be replaced with the term “structure” throughout this description in any instance of the use of the term “vehicle”.

The term “radio”, as used herein such as with reference to man-pack radios, refers to a two-way radio (or walkie-talkie). Two-way radios are distinguishable from AM and FM radios and direct broadcast satellite (DBS) radios in that they are capable of not only receiving, but also transmitting. Two-way radios are distinguishable from cellular phones in several respects including, but not limited to the fact that two-way radios are configured to allow one-to-many conversations.

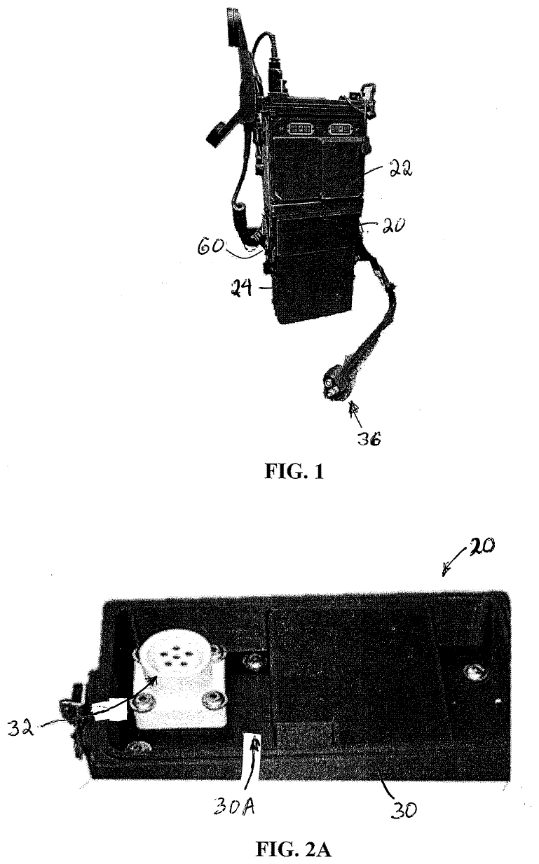

FIG. 1 shows one non-limiting embodiment of a radio communication relay module (the “module”) 20 installed on a man-pack radio 22. The module 20 may be configured to be installed on any suitable type of man-pack radio 22. In the embodiment shown, the module 20 is installed on PRC-117G tactical radio 22 manufactured by L3Harris Corporation. The PRC-117G tactical radio 22 is a 30-512 MHz band radio that incorporates many different software-defined waveforms.

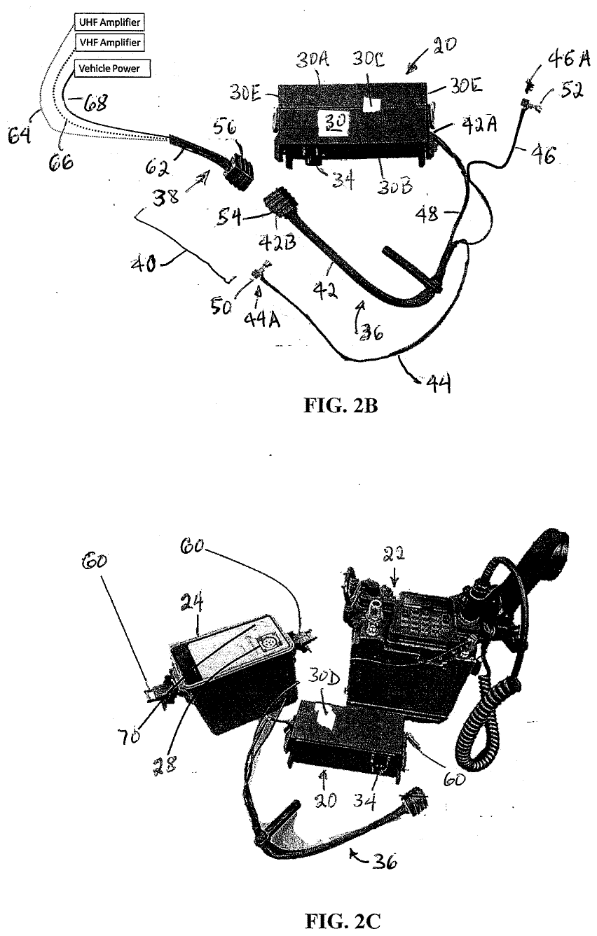

Although the module 20 can be maintained in any suitable relationship with the man-pack radio 22, as shown in FIG. 1, the module 20 may be joined between the radio 22 and the battery pack 24 for the radio 22. The module 20 may have a first (or top) surface that is joined to the bottom of the radio 22. The module 20 may have a second (or bottom) surface that is joined to the top of the battery pack 24 for the radio 22. FIG. 2A shows the top of one embodiment of the module 20. The terms “top”, “bottom”, “front”, “back”, “right”, “left”, and “side” refer to the orientation of the module shown in the drawings. It is understood that these descriptions are not limiting and that the module 20 and radio 22 may be placed in other orientations.

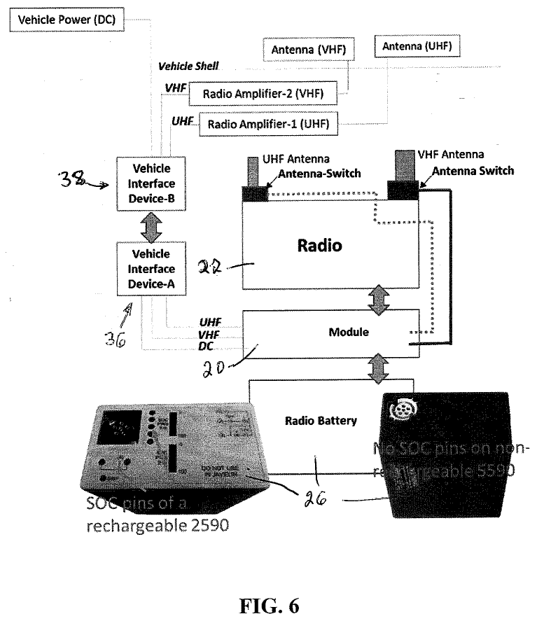

The battery pack 24 contains a battery 26 (shown in FIG. 6) that may be non-rechargeable, or it may be rechargeable. The battery pack 24 may have a connector 28 (shown in FIG. 2C) for connecting to the radio 22.

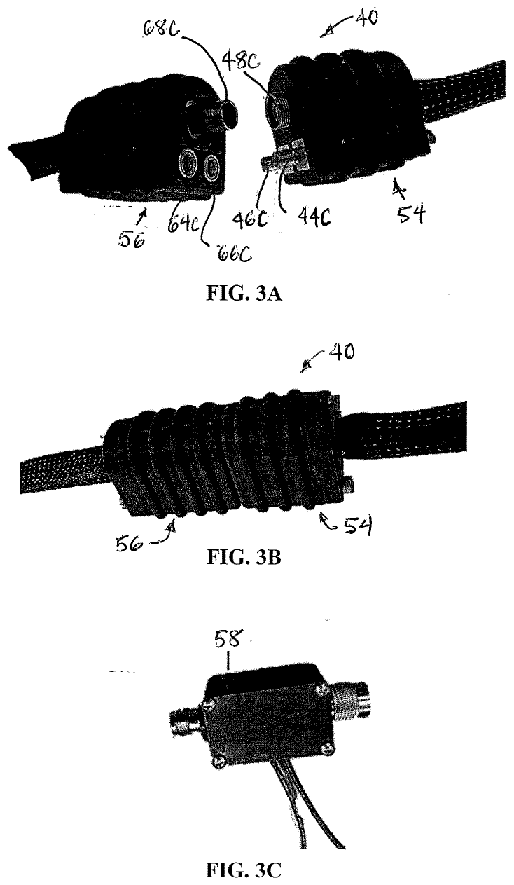

FIGS. 2A and 2B show that this embodiment of the module 20 comprises several components which may include: a housing 30, a radio interface 32 (shown in FIG. 2A), and a battery interface 34 (shown in FIG. 2B). The module 20 can be provided with a first interface device cable such as vehicle interface device-A (VID-A) 36. When the module 20 is configured to transition to use within a vehicle, the module 20 can be supplied with a second vehicle interface device-B (VID-B) 42. FIGS. 3A and 3B show that the first vehicle interface device-A (VID-A) 36 and the second vehicle interface device-B (VID-B) 38 together comprise an interface device cable assembly, such as VID-cable assembly 40. The term “vehicle interface device” may be referred to throughout this description more generically as an “interface device” to include any structures in which the module 20 may be used.

The housing 30 can be provided in any suitable configuration. In the embodiment shown, the housing 30 is in the configuration of a rectangular prism. The housing 30 has a top 30A, a bottom 30B, a front 30C, a back 30D, and sides 30E. In the embodiment shown, the top 30A of the housing 30 forms the top surface of the module 20, and the bottom 30B of the housing 30 forms the bottom surface of the module 20. The housing 30 can be made of any suitable material(s). Such materials include, but are not limited to polymeric materials, carbon fiber, and metals. The housing 30, or various portions of the module 20, may be RF-shielded to prevent electromagnetic interference introduction into the communication stream.

FIG. 2A shows that on the top 30A of the module 20 is a radio interface 32. The radio interface 32 may connect directly with the radio 22 allowing communication functionality of the radio 22 to transit through the module 20 to the structure, such as a vehicle, via the VID-cable assembly 40 (shown in FIG. 2B). Although the radio interface 32 is on top of the module in this embodiment, the radio interface 32 is not limited to a particular location on the module 20, and can be located on any surface of the module 20. The radio interface 32 can be in any suitable form. In this embodiment, the radio interface 32 is in the form of port. In this embodiment, the radio interface 32 is a female radio interface port. In other embodiments, depending on the configuration of the radio, the radio interface 32 could be in the form of a male radio interface port.

FIG. 2B shows that on the bottom 30B of the module 20 is a battery interface 34. Although the battery interface 34 is on the bottom of the module in this embodiment, the battery interface 34 is not limited to a particular location on the module 20, and can be located on any surface of the module 20. The battery interface 34 can be in any suitable form. In this embodiment, the battery interface 34 is in the form of port. In this embodiment, the battery interface 34 is in the form of a circular male battery interface port that connects to a corresponding connector on the battery pack 24. The battery interface 34 may comprise pins that detect if the battery 26 is either a rechargeable or non-rechargeable battery type. If the battery 26 is a non-rechargeable type, when the system is connected to the power source of a vehicle, or other structure, current is sent directly to the radio 22 to operate, and bypasses the battery 26. When a rechargeable battery is detected, the recharging leads 70 disconnect the battery 26 from the radio 22, and current is diverted to the battery 26 for recharging and to power the radio 22.

FIG. 2B shows that the first interface device, such as first vehicle interface device-A (VID-A) 36 comprises a cable 42 having a proximal end 42A that is joined to the module 20, and a free distal end 42B that extends outward from the module 20 and has a connector 42C on its distal end 42B. The first vehicle interface device-A (VID-A) cable 42 contains three wires and/or cables therein. These comprise: a UHF amplifier wire 44, a VHF amplifier wire 46, and a power cable 48.

The UHF amplifier wire 44 has a first end (or proximal end) 44A with a UHF antenna port 38 thereon and a second end (or distal end) 44B that terminates at the distal end of the first vehicle interface device-A (VID-A) cable 36 (which coincides with the distal end 42B of the cable 42). FIG. 3A shows that the UHF amplifier wire 44 is provided with its own connector 44C at its second or distal end. For convenience, the proximal ends of the various wires or cables may be referred to by the number of the component together with letter “A” and the distal ends of the various wires or cables may be referred to by the number of the component together with letter “B”. The connectors on the distal ends of the various wires or cables may be referred to by the number of the component together with letter “C”.

The VHF amplifier wire 46 has a first end (or proximal end) 46A with a VHF antenna port 52 thereon and a second end (or distal end) that terminates at the distal end of the first vehicle interface device-A (VID-A) cable 36. FIG. 3B shows that the VHF amplifier wire 46 is provided with its own connector 46C at its second or distal end.

The power cable 48 has a first end (or proximal end) that coincides with the proximal end 42A of the first interface device cable 36 that is joined to the module 20. The power cable 48 has a free distal end that extends outward from the module 20. FIG. 3A shows that the power cable 48 is provided with its own connector 48C at its second or distal end. The first vehicle interface device-A (VID-A) 36 may comprise an integrated connector 54 at one end that provides for the simultaneous connection to the vehicle (or other structure) UHF amplifier wire, the VHF amplifier wire, and to the power cable on the second vehicle interface device-B (VID-B) 56 connector.

FIG. 2B shows that the second interface device, such as second vehicle interface device-B (VID-B) 38 comprises a cable 62 that contains a structure UHF amplifier wire 64, a structure VHF amplifier wire 66, and a structure power cable 68, each of which is provided with its own connector at its distal end. In some cases, the UHF amplifier wire 64, and VHF amplifier wire 66, and the power cable 68 may be associated with a vehicle. In such a case, the vehicle UHF amplifier wire 64 provides a connection to the UHF antenna in the vehicle. The vehicle VHF amplifier wire 66 provides a connection to the VHF antenna in the vehicle. The vehicle power cable 68 provides power from the vehicle's battery to the module 20, and to the radio battery 26, if the radio battery is rechargeable. Each of these connectors may comprise male or female connectors. The second interface device, such as vehicle interface device-B (VID-B) 38 comprises an integrated connector 56 at its distal end that provides for the simultaneous connection of the vehicle UHF amplifier wire 64, the vehicle VHF amplifier wire 66, and a vehicle power cable 68 to the corresponding UHF wire 44, VHF wire 46, and power cable 48 of the vehicle interface device-A (VID-A) 36.

FIGS. 3A and 3B show the integrated connectors of the VID-cable assembly 40. The VID-cable assembly 40 comprises the first interface device, such as a vehicle interface device-A (VID-A) 36 and the second interface device, such as a vehicle interface device-B (VID-B) 38. The VID connectors (VID-A, VID-B) incorporate self-alignment features allowing joining of the two VID-cable sections between the radio 22 and the vehicle. Three ruggedized quick disconnect contacts, including two isolated/shielded antenna lines and an isolated auxiliary power line are integrated into the VID connectors. When VID-A and VID-B are joined, communication signals are automatically switched from the radio antennas to the vehicle's antennas via solid-state switches 58 at the radio antenna ports (which are shown in FIGS. 3C, 5, and 6).

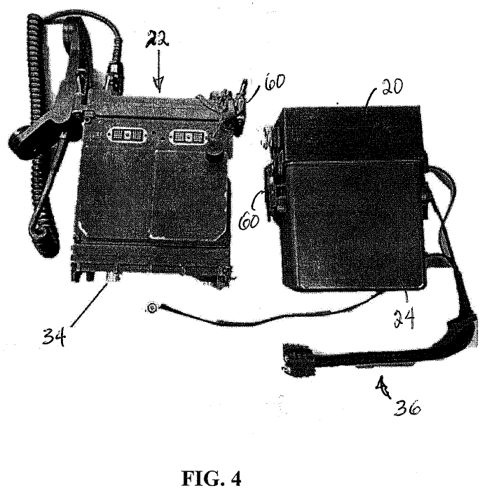

FIG. 4 shows that the module 20 attaches to both the battery pack 24 and the main radio 22 body by means of metal toggle latches (or “clips”) 60. The system is designed to connect with the radio 22 and battery pack 24 by sets of the same type of clips 60 that the radio 22 and battery pack 24 already clip together with. This configuration allows for maximum stability of platform while being in line with user demands. Using the same interface-clips also minimizes additional training required to learn how to install the system.

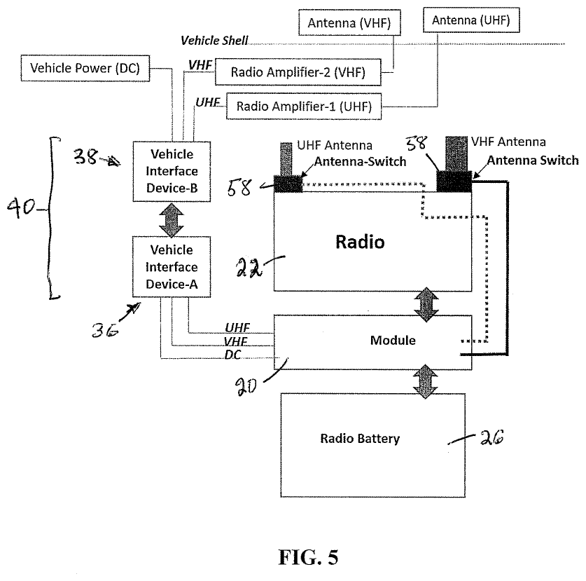

FIG. 5 shows the relationship of the main components of the interface module 20, the radio 22, and the vehicle amplifiers and power. The module 20 comprises a relay bank, which controls the battery-charge-circuit and activates antenna switches. The relay bank uses contact pins on the bottom 30B of the module 20 to engage state-of-charge (SOC) pins on the top of the battery pack 24 determine if the battery 26 powering the radio 22 is rechargeable or not. If no SOC pins are present, the battery 26 is not rechargeable, and the relay bank switches the contacts, disabling the battery 26 and powering the radio 22 from the auxiliary Vehicle Interface Device (VID) source (the vehicle power source or other power source). (The terms “power source” and “power supply” may be used interchangeably.) When a rechargeable-battery 26 is detected by the presence of SOC pins, the relay bank disables the contacts from the battery 26 to the radio 22 and switches them to the charge circuit while simultaneously powering the radio 22 from the auxiliary VID source. In the latter case, a power-manager within the module 20 detects the current provided via the VID cable, and adjusts and regulates the voltage provided to the radio 22 and rechargeable battery 26 to the necessary levels.

The auxiliary power from the vehicle (or other source), may provide between 9 and 36 volts DC, and may be provided to the system by way of: a NATO connector, a vehicle cigarette lighter, a standard 12 volt plug, or other approved means.

The antenna switches 58 are located between the radio 22 and the respective antennae. The antenna switches 58 are activated when auxiliary power is provided to the module 20 via the vehicle interface device (VID) so that communication signals are automatically switched from the radio antennas to the vehicle's antennas.

The radio communication relay system is designed to allow radio operators to quickly transition from a dismounted operation (that is, when it is not in a vehicle or other structure) to a vehicle-mounted operation (or operation in another structure) with a single interface. The module 20 may be connected between the radio 22 and battery pack 24 of a military radio. When the radio 22 is being used in a dismounted mode, the distal end of the vehicle interface device 36 is not connected to anything. In dismounted operations, the radio 22 utilizes the antennas mounted on the radio 22. The UHF antenna port 50 and the VHF antenna port 52 are connected to the antennas mounted on the radio 22.

Radio operators can then climb into a vehicle (or enter another structure) equipped with the second interface device 42, and simply merely plug their adapter (first interface device 36) attached to their manpack radio 22, into the vehicle-side adapter (second interface device 42), and the man-pack radio 22 switches automatically to vehicle-operations-mode. Once connected to the vehicle, the radio 22 is automatically reconfigured to utilize the vehicle's antenna amplifiers for extended communications range and to the vehicle power to power the radio 22 and allow the radio battery 26 to be charged (if it is a rechargeable battery). Radio-operators can utilize their personal communications gear (helmet/headsets, push-to-talk, etc.) already integrated with their ensemble to seamlessly continue operations.

The radio communication relay module (the “module”) 20 can be used with any radio communication device that is used outside and then carried into a structure where the radio signal would otherwise be attenuated by the structure. Military members carrying tactical radios need to transmit while walking around with their radios as well as when they climb into a vehicle or enter a building. This system is also useful for non-military personnel who wear radios to communicate, including first responders including medical personnel, firefighters and police, and utility workers. They face the same challenges of trying to maintain communication using the same radio both inside and outside RF-shielded structures like vehicles and buildings. In addition, personnel working aboard ships at sea require radios when moving about the ship. Repeater-systems are installed throughout the vessel allow the RF-transmission to propagate outside the ship. The system described herein would allow the ship personnel to attach their body-worn radio to the ship's power and antenna-amplifier/repeater system when they are at their ship workstation.

There are numerous, non-limiting embodiments of the invention. All embodiments, even if they are only described as being “embodiments” of the invention, are intended to be non-limiting (that is, there may be other embodiments in addition to these), unless they are expressly described as limiting the scope of the invention. Any of the embodiments described herein can also be combined with any other embodiments in any manner to form still other embodiments.

For example, the radio communication relay module (the “module”) 20 system can be configured such that it remains in a vehicle or other structure, rather than being connected to the user's radio 22 when the radio is used in a dismounted operation. In such a case, when a user enters the vehicle or structure and wants to use the system, they then connect their radio 22 to the system. In some embodiments, the module 20 may be configured so that it need not directly connected to the radio and the battery when in use. In some embodiments, the module 20 may be configured so that it need not be connected between the radio and the battery.

The interfaces for radio communication systems described herein can provide a number of advantages. It should be understood, however, that these advantages need not be required unless they are set forth in the appended claims.

The radio communication relay module (the “module”) 20 will allow people using radios in and out of vehicles to quickly transition from dismounted to mounted operations with a single connect/disconnect interface. The module will charge rechargeable radio batteries while the radio operator is in the vehicle ensuring the batteries are completely topped off and ready for extended operations while away from their vehicle. Radio operators will save time not having to load cryptography codes and frequencies onto an additional radio. Program managers will save money only having to buy a single radio equipped with the radio communication relay module (the “module”) 20 instead of two radios to accomplish missions. Military members will be able to use the vehicle radio to communicate to air support while riding in a vehicle and thus take away the need to stop and exit the vehicle before using the radio.

As used herein, an element or step recited in the singular and preceded with the word “a” or “an” should be understood as including the plural of such elements or steps, unless the plural of such elements or steps is specifically excluded.

The terms “joined” and “connected” (and variations thereof such as “joining”, “connecting”, etc.), as used herein, encompass configurations in which an element is directly secured to another element by affixing the element directly to the other element; configurations in which the element is indirectly secured to the other element by affixing the element to intermediate member(s) which in turn are affixed to the other element; and configurations in which one element is integral with another element, i.e., one element is essentially part of the other element. The terms “joined” and “connected” include both those configurations in which an element is temporarily joined to another element, or in which an element is permanently joined to another element.

The disclosure of all patents, patent applications (and any patents which issue thereon, as well as any corresponding published foreign patent applications), and publications mentioned throughout this description are hereby incorporated by reference herein. It is expressly not admitted, however, that any of the documents incorporated by reference herein teach or disclose the present invention.

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described.

Accordingly, departures may be made from such details without departing from the scope of the general inventive concept.

What is claimed is:

1. A radio communication relay module for interfacing with a portable radio having a battery, and for connecting to an external antenna and a power supply of a structure, said module comprising:
a housing comprising a radio interface configured to connect to a portable radio and a battery interface configured to connect to the battery of the portable radio, wherein the battery interface comprises a mechanism to detect whether the battery of the radio is non-rechargeable or rechargeable; and
a first interface device cable having a proximal end joined to the housing and a distal end spaced away from the housing, wherein the distal end of said first interface device cable is configured to at least indirectly connect said module to a structure's external antenna and power supply.

2. The radio communication relay module of claim 1 wherein the module is configured to be joined between the radio and the battery for the radio.

3. The radio communication relay module of claim 2 wherein the module comprises clips for joining the module between the radio and the battery.

4. The radio communication relay module of claim 1 wherein the mechanism to detect whether the battery is non-rechargeable or rechargeable comprises battery interface pins to determine whether state of charge (SOC) pins are present on the battery for the radio.

5. The radio communication relay module of claim 4 wherein the battery interface mechanism is configured to send current directly from the structure's power supply to the radio detect when the battery is detected to be non-rechargeable.

6. The radio communication relay module of claim 1 wherein the battery interface mechanism is configured to send current from the structure's power supply to the battery and to power the radio when the battery is detected to be rechargeable.

7. A radio communication relay system comprising the radio communication relay module of claim 1 and a second interface device cable that is configured to be joined to a structure's antenna and power supply, said second interface device cable having a proximal end configured to be joined to a structure's antenna and power supply and a distal end spaced away from the structure wherein the distal end of said second interface device cable is configured to connect with the distal end of the first interface device cable.

8. The system of claim 7 wherein the first and second interface device cables each have a pair of isolated antenna lines and an isolated auxiliary power line therein.

9. The system of claim 7 wherein the distal ends of the first and second interface device cables each comprise a plug-in connector thereon, said contacts comprising a first contact and a second contact, wherein the first contact and the second contact are configured to mate with each other.

10. The system of claim 9 further comprising a switch for automatically switching from the radio's antenna to the structure's antenna when the first contact and the second contact mate with each other.

11. A method of interfacing a portable radio having a battery with a structure's antenna and power supply, said method comprising:
a) providing a radio communication relay module that is joined to a portable radio having a battery, said module being configured to interface with the radio and with a structure's antenna and power supply, said module comprising:
a housing comprising a radio interface connected to a portable radio and a battery interface connected to the battery of the portable radio;
a first interface device cable having a proximal end joined to the housing and a distal end spaced away from the housing, wherein the distal end of the first interface device cable is configured to connect said module at least indirectly to a structure's antenna and power supply, said; and
b) providing a second interface device cable that is joined to operatively connected to a structure's antenna and power supply; and
c) bringing said radio with said radio communication relay module joined thereto into the structure; and
d) connecting said first interface device cable and said second interface device cable, wherein said radio communication relay module is configured so that when said first and second interface device cables are connected, the radio uses the structure's antenna and power system.

12. The method of claim 11 wherein the structure is one of the following: a vehicle, a building, or a ship.

13. The method of claim 11 wherein when the radio battery is rechargeable, and the first and second interface device cables are connected, the structure's power system powers the radio and recharges the radio's battery.
